(19) United States
(12) Patent Application Publication
(10) Pub. No.: US 2008/0006759 A1
(43) Pub. Date: Jan. 10, 2008

(54) Active vibration isolation system with improved sensor/actuator matching

(75) Inventor: Peter Heiland, Raunheim (DE)

Correspondence Address: DEMONT & BREYER, LLC, 100 COMMONS WAY, Ste. 250, HOLMDEL, NJ, 07733, US

(73) Assignee: INTEGRATED DYNAMICS ENGINEERING GMBH, Raunheim (DE)

(21) Appl. No.: 11/766,616

(22) Filed: Jun. 21, 2007

(30) Foreign Application Priority Data
Jun. 23, 2006 (EP) 06012955

(51) Int. Cl. F16F 15/03

(52) U.S. Cl. 248/638

(57) ABSTRACT

The invention relates to an active vibration isolation system in which the effective axis of a sensor essentially corresponds to the effective axis of an actuator and the sensor and the actuator are arranged close to one another.

### FIELD OF THE INVENTION

The invention relates to an active vibration isolation system in which at least one sensor is provided for the purpose of detecting movements of the load to be mounted and at least one actuator is provided for the purpose of active counter-control.

### BACKGROUND OF THE INVENTION

Vibration isolation systems are known. For example, DE 698 17 750 T2 (inventors: Erik Loopstra, Peter Heiland) thus exhibits a vibration isolation system which is designed to hold a lithography appliance. In this case, the load which is to be mounted and typically comprises a table and components mounted on the latter, such as manufactured installations, is mounted on air bearings.

In order to improve vibration isolation, so-called active vibration isolation systems have sensors and actuators which can be used for deliberate counter-control. In this case, the sensors detect movements of the load to be mounted. Actuators of the vibration isolation system are driven using a control device and counteract vibrations which may both act on the system from the outside and may be generated by the load to be mounted.

The demands imposed on such vibration isolation systems are becoming more and more stringent in the semiconductor industry, in particular, with increasing miniaturization of the components.

The disadvantage of known vibration isolation systems is that the signals which are measured by the sensors and represent the movements of the load to be isolated are not always completely correlated with the signals needed to counter-control the movement using the actuators.

It can be assumed that this effect originates, inter alia, from the fact that the load to be isolated, in particular the table on which the components to be isolated are arranged, is considered to be a rigid body.

However, the movements of the table are not the same at each point. Therefore, the table is not an ideal rigid body and is itself subject to vibrations.

Furthermore, a sensor which is, for example, situated between two positions which execute opposite directions of movement cannot measure a movement. Rather, this sensor provides a signal only when it also detects rotational movements.

Another disadvantage of known vibration isolation systems is that crosstalk may occur between the sensors and the actuators, that is to say the sensors and actuators may interfere with one another, thus likewise reducing the isolation effect of the system.

### OBJECT OF THE INVENTION

In contrast, the invention is based on the object of providing a vibration isolation system in which the abovementioned disadvantages of the prior art are reduced.

In particular, the object of the invention is to improve the interaction between the sensors and actuators.

Another object of the invention is to provide a sensor/actuator combination in which the output signal from the sensor is correlated as accurately as possible with the input signal of the actuator.

Another object of the invention is to reduce crosstalk between the sensors and actuators.

### SUMMARY OF THE INVENTION

The object of the invention is achieved simply by an active vibration isolation system as claimed in one of the independent claims.

Preferred embodiments and developments of the invention can be gathered from the respective subclaims.

Accordingly, provision is made of an active vibration isolation system having at least one sensor for detecting movements. The movements are, in particular, vibrations which are coupled into the system both by external influences such as seismic tremors and by the mass to be isolated itself, for instance on account of the movement of machine elements.

The sensor detects movements along and/or around at least one first axis. It is therefore a sensor which detects translatory movements and/or rotational movements. An axis of the sensor defined in this manner defines that this axis essentially runs in the direction of movement relative to a translatory movement in which the sensor is effective or the axis runs essentially parallel to the axis of the rotational movement in the case of a sensor which detects rotational movements.

The active vibration isolation system also has at least one actuator for actively controlling a load to be isolated. This actuator may also be in the form of a translatory actuator, for example a linear motor. It may also be an actuator which exerts a torque on the system or the load to be isolated. In a manner corresponding to the definition of the sensor, this actuator is assigned a second axis. The actuator can thus be effective at least in one direction and/or can generate a torque. The effective axis of the actuator is defined using the direction or the axis of rotation.

According to the invention, the axis which is assigned to the sensor is essentially parallel to the axis which is assigned to the actuator. Aligning the two axes, which can also be referred to as effective axes, reduces interference in the correlation between the sensor signal and actuator signal, which arises, in particular, on account of the load which is to be isolated and is not in the form of an ideal rigid body.

In one preferred embodiment of the invention, the first axis is at a distance of less than 15 cm, preferably less than 5 cm, and particularly preferably less than 3 cm, from the second axis. The effective axis of the sensor is thus as close as possible to the effective axis of the actuator.

Ideally, the two axes are essentially on top of one another, as is provided for in one preferred embodiment of the invention.

The angle between the first and second axes, which are essentially parallel, is less than 15°, preferably less than 8°, and particularly preferably less than 3°.

In one development of the invention, at least one sensor of the vibration isolation system is designed to detect movements in at least one degree of rotational freedom and at least one degree of translatory freedom, the axis of the degree of rotational freedom essentially corresponding to the direction of the degree of translatory freedom. The sensor thus measures two degrees of freedom whose effective axes are above one another. The sensor is preferably combined with an actuator which is likewise effective in one degree of rotational freedom and one degree of translatory freedom.

In one development of the invention, the vibration isolation system has at least two, preferably three, sensors with respective associated actuators whose axes are essentially parallel. If these are actuator/sensor combinations which are each effective in one degree of rotational freedom and one degree of translatory freedom, it is possible to provide a system which provides active control in all six degrees of freedom.

In order to avoid vibrations, in particular seismic vibrations, being coupled into the system, the actuators preferably contactlessly engage with the load to be isolated. The actuator and sensor are preferably coupled to one another by means of an essentially rigid connection. Correlation discrepancies between the sensor signal and requisite actuator control are thus reduced.

The vibration isolation system preferably has active control in at least two, preferably three, degrees of translatory freedom and thus enables an isolation effect in all three spatial directions.

In one development of the invention, the vibration isolation system is designed for active control with respect to at least one, preferably two, and particularly preferably three, degrees of rotational freedom.

In another preferred embodiment of the invention, the sensor and associated actuator are arranged in a housing. This provides a compact sensor/actuator combination which, in addition to the compact design and simple integration in the system, even subsequently in existing systems, is optimally matched.

The invention also relates to a vibration isolation system which comprises at least one sensor for detecting movements, in particular vibrations, in at least one degree of freedom, and at least one actuator for actively controlling a load to be isolated in at least the degree of freedom of the sensor.

In this case, the actuator and the sensor are at a distance of less than 25 cm, preferably less than 10 cm, and particularly preferably less than 5 cm, from one another.

The sensor and the actuator are thus as close as possible to one another in order to reduce correlation discrepancies between the sensor signal and actuator control.

It is preferred for the sensor and the actuator to not only be arranged as close as possible to one another but also to have a common effective axis.

Sensors which operate on a magnetic, electrostatic or piezo principle can be used as sensors; inductively operating geophones are provided, in particular.

The actuators preferably also operate on a magnetic, piezo or electrostatic principle. In particular, electromagnetic drives, preferably contactlessly engaging drives such as Lorentz motors, are used.

One preferred embodiment of the invention uses an actuator which is based on a principle that is different to that of the sensor. Crosstalk between the actuator and the sensor is thus largely avoided.

Piezo or electrostatic sensors are preferably used, whereas the actuator is in the form of a magnetic actuator. It is thus possible to provide a sensor/actuator combination in which the actuator and the sensor are close to one another, in particular can be arranged in a housing, and crosstalk between the two components scarcely occurs.

The sensor is preferably in the form of a piezo or electrostatic sensor, whereas the actuator is in the form of a magnetic actuator, in particular in the form of a contactless Lorentz motor.

### BRIEF DESCRIPTION OF THE DRAWINGS

The invention shall be explained in more detail below with reference to the drawings of FIG. 1 and FIG. 2.

FIG. 1 shows a schematic view of an exemplary embodiment of a vibration isolation system,

FIG. 2 schematically shows an exemplary embodiment of an actuator/sensor combination.

### DETAILED DESCRIPTION OF THE DRAWINGS

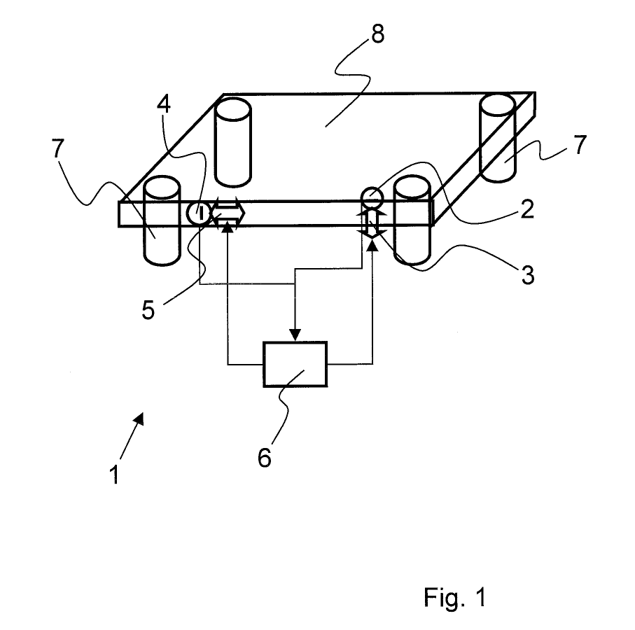

The fundamental parts of an exemplary embodiment of a vibration isolation system 1 shall be explained in more detail with reference to FIG. 1.

The vibration isolation system 1 comprises a plate 8 which is mounted on air bearings 7 such that it is isolated against vibration. The components or machine elements (not illustrated) which are to be mounted such that they are isolated against vibration can be arranged on the plate 8, so that they form, together with the plate 8, the load to be isolated.

The vibration isolation system 1 is in the form of an active vibration isolation system and comprises a control device 6 which is connected to sensors 2, 4. The sensors 2, 4 detect movements, in particular vibrations, of the plate 8 and forward the signal to the control device 6. The control device 6 uses the input signals to calculate compensation signals and forwards these compensation signals to the actuators 3, 5. Movements of the plate 8 are thus counteracted using the actuators 3, 5.

In order to achieve optimal interaction between the sensors and actuators, this exemplary embodiment provides sensor/actuator combinations in which the sensor and the actuator 2, 3; 4, 5 are respectively close to one another. A separate sensor/actuator combination 2, 3 is provided for control in the vertical direction. The sensor 2 detects changes in movement in the vertical direction, that is to say has a vertical effective axis.

The sensor 2 is assigned an actuator 3 which is likewise effective in the vertical direction. The sensor 2 and the actuator 3 thus have the same effective axis and are close to one another.

The same applies to the sensor/actuator combination 4, 5 provided for controlling the system in a horizontal direction.

A third sensor/actuator combination which is perpendicular to the sensor/actuator combinations described above and makes it possible to control the system in all three spatial directions is not illustrated in the drawing.

In order to keep crosstalk between the actuators 3, 5 and sensors 2, 4 as low as possible or to even avoid it entirely, a piezo sensor 2, 4 is respectively combined with a magnetic actuator 3, 5.

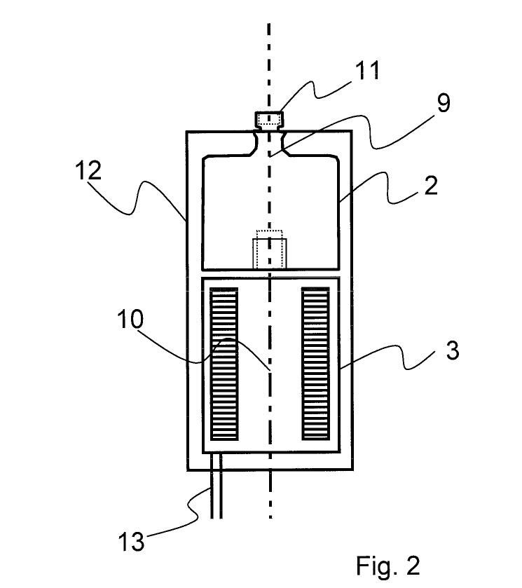

The fundamental components of a sensor/actuator combination shall be explained in more detail with reference to FIG. 2. In this exemplary embodiment, a sensor 2 and an actuator 3 are accommodated together in a housing 12. The housing 12 which is preferably essentially formed from metal ensures an essentially rigid connection between the actuator 3 and the sensor.

The sensor 2 is a piezo sensor which can be connected to a control device (not illustrated) using a BNC socket 11.

The actuator 3 is a magnetic actuator in the form of a linear motor which likewise has a connection 13 for connection to a control device (not illustrated). In this example, the sensor/actuator combination is designed to actively control vertical movements, that is to say translatory movements along the axes 9, 10.

The axis in the direction in which the sensor is effective (the first axis 9) corresponds to the axis in whose direction the actuator exerts force (the second axis 10). Therefore, the sensor signal is correlated in an essentially accurate manner with the compensation signal for the actuator 3.

It goes without saying that the invention is not restricted to a combination of the features described above but rather a person skilled in the art will combine the features, if appropriate.

### LIST OF REFERENCE SYMBOLS

1 Vibration isolation system
2 Sensor
3 Actuator
4 Sensor
5 Actuator
6 Control device
7 Air bearing
8 Plate
9 First axis
10 Second axis
11 BNC socket
12 Housing
13 Connection

1. An active vibration isolation system comprising
at least one sensor for detecting movements along and/or around at least one first axis, and
at least one actuator for actively controlling a load to be isolated in the direction of and/or around at least one second axis,
wherein the first and second axes are essentially parallel.

2. The active vibration isolation system as claimed in claim 1, wherein the first axis is at a distance of less than 15 cm from the second axis.

3. The active vibration isolation system as claimed in claim 1, wherein the angle between the first and second axes is less than 15°.

4. The active vibration isolation system as claimed in claim 1, wherein the sensor is designed to detect movements in at least one degree of rotational freedom and at least one degree of translatory freedom, the axis of the degree of rotational freedom essentially corresponding to the direction of the degree of translatory freedom.

5. The active vibration isolation system as claimed in claim 1, wherein the vibration isolation system has at least two sensors with respective associated actuators whose axes are respectively essentially parallel.

6. The active vibration isolation system as claimed in claim 1, wherein the actuator or actuators contactlessly engage(s) with the load to be isolated.

7. The active vibration isolation system as claimed in claim 1, wherein the actuator and the sensor are connected to one another by means of an essentially rigid connection.

8. The active vibration isolation system as claimed in claim 1, wherein the vibration isolation system has active control in at least two degrees of translatory freedom.

9. The active vibration isolation system as claimed in claim 1, wherein the vibration isolation system has active control in at least one degree of rotational freedom.

10. The active vibration isolation system as claimed in claim 1, wherein a sensor and an associated actuator are respectively arranged in a housing.

11. The active vibration isolation system comprising
at least one sensor for detecting movements in at least one degree of freedom, and
at least one actuator for actively controlling a load to be isolated in at least the degree of freedom of the sensor,
wherein the actuator and the sensor are at a distance of less than 25 cm from one another.

12. The active vibration isolation system as claimed in claim 11,
the sensor and the actuator being based on a magnetic, piezo or electrostatic principle,
wherein the actuator is based on a principle that is different to that of the sensor.

13. The active vibration isolation system as claimed in claim 12, wherein the sensor is in the form of a piezo or electrostatic sensor and the actuator is in the form of a magnetic actuator.
